(19) United States
(12) Patent Application Publication
(10) Pub. No.: US 2007/0197184 A1
(43) Pub. Date: Aug. 23, 2007

(54) Method and apparatus for minimizing harmonic interference in synchronous radio receivers by apodization

(76) Inventors: William S. Yerazunis, Acton, MA (US); Darren L. Leigh, Belmont, MA (US); Paul H. Dietz, Hopkinton, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/360,903

(22) Filed: Feb. 23, 2006

(51) Int. Cl. H04B 1/10

(52) U.S. Cl. 455/296

(57) ABSTRACT

A method and apparatus for minimizing harmonic interference in a radio receiver is presented. A received radio signal is periodically switched to an integrator as a positive signal, periodically switched to the integrator as a negative signal, and the integrator is periodically switched to ground to block the received signal from the integrator to minimize the harmonic interference.

### FIELD OF THE INVENTION

This invention relates generally to radio receivers, and more particularly to minimizing harmonic interference in synchronous radio receivers.

### BACKGROUND OF THE INVENTION

Prior art radio receivers use an analog filter centered around one or more intermediate frequencies (IF) to minimize interference at some harmonic of a carrier frequency. This is followed by a conventional peak-riding, synchronous, or quadrature demodulator to make a conversion to a base band signal.

FIG. 1 shows a commutator 100 of a conventional radio receiver. The commutator 100 includes an analog inverter 110, an oscillator 120, an integrator 130, and a two-position commutator switch 140. The oscillator operates at a frequency of a carrier signal. The conventional commutator switch 140 has only two positions, plus (+) and minus (−).

An input received radio signal 101 is alternately fed directly to the integrator 130 as a positive signal (+) via the first position of the switch 140, or as an inverted signal (−) via the second position of the switch, at a rate determined by the oscillator 120.

With the prior art demodulation methods, any interference that passes the conventional analog filter stages is demodulated and is present in the output signal as interference. In the case of a conventional detector, all of the interference appears as part of the base band signal at the detector output 102.

In the case of a synchronous detector, odd harmonics appear at the detector output when the harmonics are in phase with a synchronous pilot signal. If the pilot signal is not precisely at the interference signal frequency, then the interference heterodynes in and out of phase with the synchronous pilot signal, yielding a resulting signal with interference fading in and out at the heterodyne rate as the interfering signal is split between the (+) and (−) halves of the synchronous commutator.

In the case of a quadrature demodulator, the interference rotates between the in-phase and quadrature components. If phase-lock is used to control the quadrature pilot, then the interference can ‘pull’ the quadrature pilot frequency away from the desired signal onto the interference center frequency.

All three of these issues are worse when the interference is at an odd harmonic of the signal frequency. In that case, both a synchronous demodulator and a quadrature demodulator pass the odd harmonic interference without attenuation as though the interference was at the desired carrier frequency.

It is desired to minimize such harmonic interference.

### SUMMARY OF THE INVENTION

The embodiments of the present invention minimize harmonic interference in a radio receiver by changing a commutator element to include “off” periods centered around zero crossings of a carrier frequency.

Optimally, for third harmonic interference, the synchronous receiver commutator is modified by adding “off” periods extending from −30 to +30 degrees around each zero crossing of the desired carrier frequency, i.e., corresponding to −90 to +90 degrees of the interfering third harmonic. Other durations of the “off” period can be used for minimizing other interference harmonics.

A quadrature detector can be modified similarly by adding “off” periods to a quadrature section to improve desired carrier signal tracking in the quadrature signal. Specifically, consider the standard construction of a quadrature detector as being a pair of synchronous demodulators, one operated at the desired carrier frequency and a phase angle of zero, and the second being operated at the desired carrier frequency and a phase angle of ninety degrees. OFF periods are added-to the zero-phase detector section from −30 to +30 degrees, and from +150 to +210 degrees similarly to the synchronous detector embodiment of the invention. The corresponding OFF periods for the ninety-degree offset synchronous detector section is 90±30 degrees, and 270±30 degrees, which are OFF periods from 60 to 120 degrees and 240 to 300 degrees as compared to the reference carrier at the desired frequency and zero phase.

### BRIEF DESCRIPTION OF THE DRAWINGS

FIG. 1 is a block diagram of a prior art commutator of a radio receiver;

FIG. 2A is a block diagram of a commutator of a radio receiver using synchronous detection according to an embodiment of the invention;

FIG. 2B is a block diagram of a commutator of a radio receiver using quadrature detection according to an embodiment of the invention;

FIG. 3 is a wave form of a signal with a carrier frequency F;

FIG. 4 is a wave form of an interfering third-harmonic at a carrier frequency 3F;

FIG. 5 is a waveform after commutator switching according to an embodiment of the invention is applied to a third harmonic signal; and

FIG. 6 is a waveform after commutator switching according to an embodiment of the invention is applied to a first harmonic signal.

### DETAILED DESCRIPTION OF THE PREFERRED EMBODIMENT

The embodiments of the invention modify a conventional synchronous radio receiver by apodization. Apodization is sometimes also called tapering. In the prior art, apodization is mostly used in processing optical and acoustic signals. In optical signals, apodization can reduce the Gibbs phenomenon known as ‘ringing,’ which is produced in a spectrum obtained from, for example, a truncated interferogram. A tapering function is used to bring an interferogram smoothly down to zero at the edges of a sampled region. This suppresses undesired side lobes.

Apodization can also be performed by obscuring a central portion of a lens aperture in order to recover high spatial frequencies lost in low-pass filtering. It is also used to ‘stop-down’ lenses in order to screen off an outer portion of a lens, which can introduce spherical aberrations, and increase a depth of field.

The embodiments of the invention apply the principle of apodization to received radio signals to partially block a received signal and increase an overall signal to noise ratio (SNR).

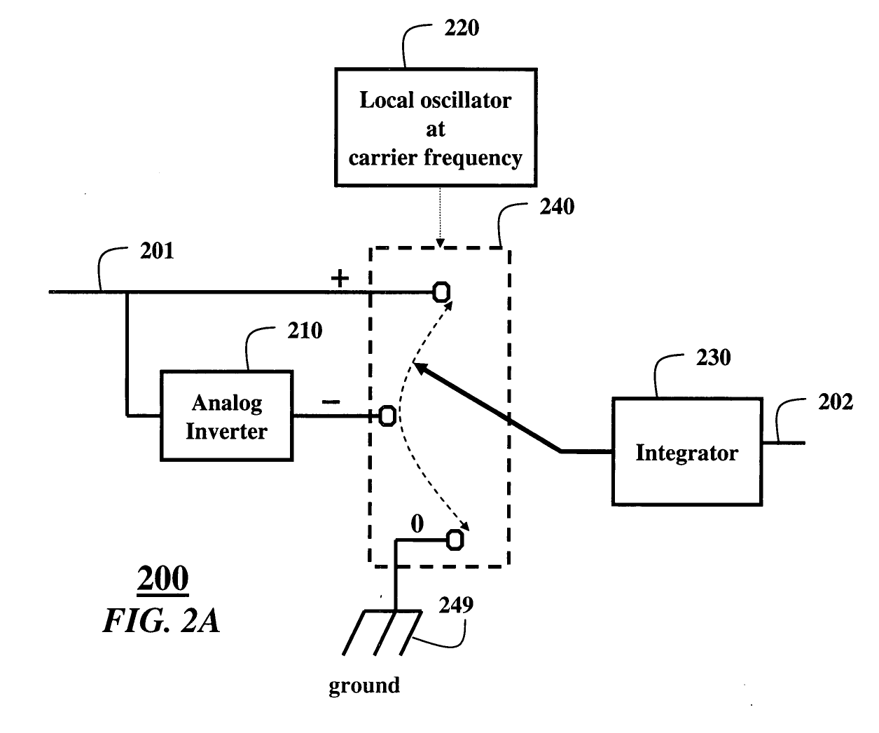

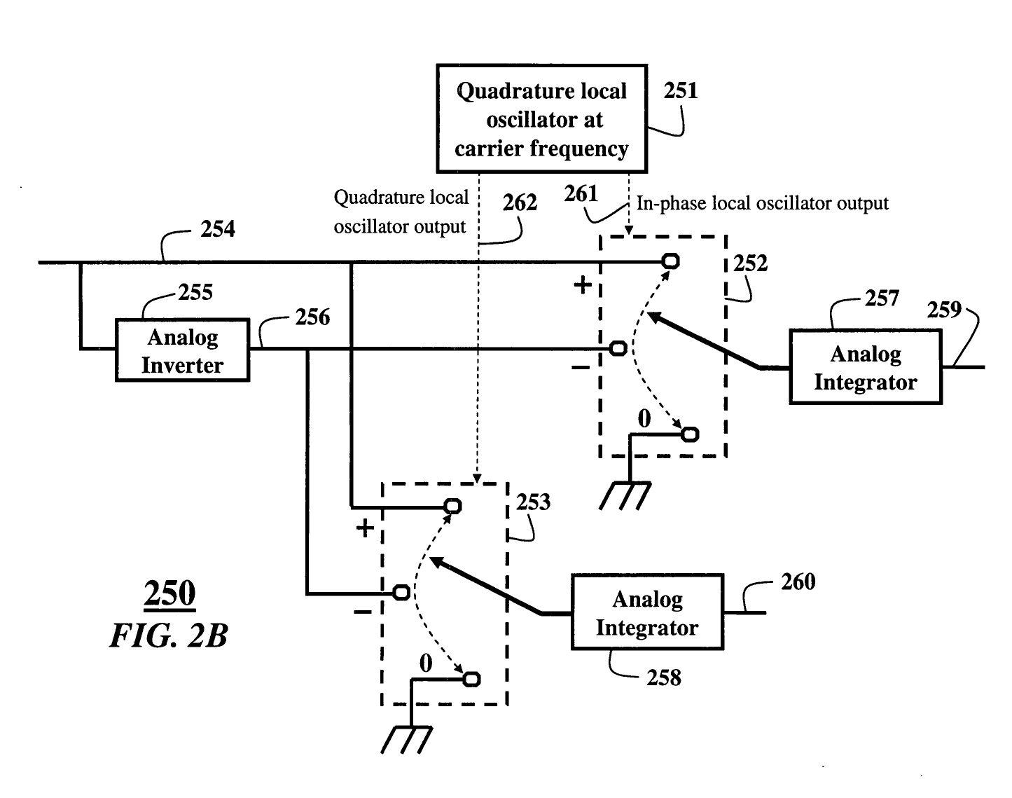

FIG. 2A shows a commutator 200 of a radio receiver according to an embodiment of the invention. The commutator 200 includes an analog inverter 210, an oscillator 220, an integrator 230, and a three position commutator switch 240.The oscillator operates at a carrier frequency. The commutator switch 240 has three positions: plus (+), minus (−), and off (0).

An input received signal 201 is alternately fed directly to the integrator 130 as a positive signal (+) via the first position of the switch, as an inverted or negative signal (−) via the inverter and second position of the switch, or not at all by connecting the inverter to ground 249 via a third position of the switch, at a rate determined by the oscillator 220 operating at the rate of the carrier frequency.

If the received signal is at frequency F, then a synchronous or quadrature detector detects this signal, as well as any odd harmonic of the signal, such as at 3F, 5F, 7F, etc.

For example, at 100 KHz, the third harmonic is at 300 KHz. Odd harmonics are particularly of interest in RF interference problems because nonlinear junctions such as diodes (even the weak diodes produced by corrosion effects in connectors) can convert first-harmonic RF carriers to third harmonic interference signals. The difficulty with rejection of third harmonics is that at least one lobe of the sine wave of the interference carrier appears in an unbalanced form with respect to the synchronous detector and in a way not easily distinguishable from the desired signal carrier at frequency F. Therefore, the third harmonic interference is accepted by the detector. In the general case, a synchronous detector effectively rejects all even harmonic interference, and also rejects non-harmonically related interference, but allows odd harmonic interference to pass through to the output.

In one embodiment of the invention, the sampling parameters are modified to provide blocking apodization. Because there is only one sine wave lobe at the third harmonic that is unbalanced in each half-cycle, the switch 240 blocks the first half of the first lobe and the last half of the last lobe in each half-cycle at the carrier frequency F.

This changes the interfering carrier at the frequency 3F, from an odd function to an even function, which is blocked perfectly by the synchronous detector, as shown in FIG. 5.

For third-harmonic interference, the following switching protocol is followed with respect to the carrier at frequency F. Table A describes settings of the commutator switch 240 to eliminate third-harmonic interference.

TABLE A

| Phase of Carrier Signal | State of Commutator Switch |
|---|---|
| 0 to 30 degrees | “Off” - no connection to integrator |
| 30 degrees to 150 degrees | “Plus” - integrate positive signal |
| 150 degrees to 210 degrees | “Off” - no connection to integrator |
| 210 degrees to 330 degrees | “invert” - integrate negative signal |
| 330 degrees to 360 degrees | “Off” - no connection to integrator |

Similarly, to block fifth-harmonic interference at a carrier frequency 5F, the first half of the first lobe and the last half of the last lobe of the carrier are blocked; in this case it would be OFF from 0±36 degrees and 180±36 degrees.

The general case formula for the optimal OFF periods for the N^{th} harmonic interference is to switch the commutator to the OFF position from 0±(180/N) degrees and 180±(180/N) degrees.

Thus, the apodization of the synchronous receiver can be tuned to reject any major harmonic interference at the carrier frequency in the output signal 202.

FIG. 2B shows a commutator 250 of a radio receiver according to an alternative embodiment of the invention, as it would be used in a quadrature demodulator. A local oscillator 251 is used to produce the local carrier as before, both in the in-phase signal 261 and in the 90-degree phase-shifted quadrature local oscillator signal 262. These signals are applied to first and second three-position commutator switches 252 and 253, respectively. The direct version of the input signal 254 is applied to the “+” inputs of the commutator switches 252 and 253, and analog inverter 255 produces an inverted version 256 of the input signal, which is applied to the “−” inputs of both commutator switches. The output of commutator switches 252 and 253 are integrated by first and second analog integrators 257 and 258, respectively, which give the outputs 259 and 260 of this quadrature demodulator.

The quadrature demodulators 252 and 253 are switched similarly to FIG. 2A. Commutator switches 252 and 253 obey the same rules as in FIG. 2A, that is, as shown in Table A above.

Because quadrature commutator 253 is operated from the quadrature output 262 of the local oscillator, which is 90 degrees delayed from the in-phase output 261, the commutator switch 253 lags 90 degrees behind the in-phase commutator switch 252. The switching table for this quadrature commutator is as shown in Table B.

Note also that Table B starts at −90 degrees compared to the in-phase local carrier signal, and extends to 270 degrees. This is a full table, since 270 degrees is in fact the same phase angle as −90 degrees.

TABLE B

| | In-Phase Carrier Phase | State of |
|---|---|---|
| | (equals quadrature −90 | Commutator |
| Quadrature Carrier phase | degrees) | Switch |
| 0 to 30 degrees | −90 to −60 degrees | “Off” |
| 30 degrees to 150 degrees | −60 degrees to 60 degrees | “Plus” |
| 150 degrees to 210 degrees | 60 degrees to 120 degrees | “Off” |
| 210 degrees to 330 degrees | 120 degrees to 240 degrees | “Invert” |
| 330 degrees to 360 degrees | 240 degrees to 270 degrees | “Off” |

Table B

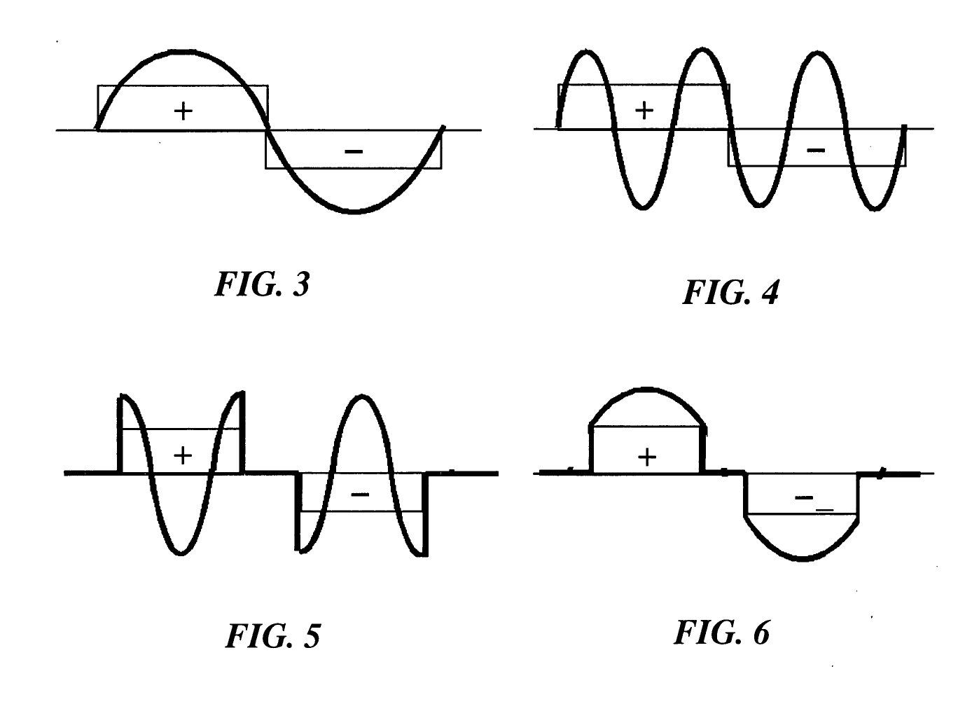

FIG. 3 shows a received signal with carrier frequency F. Typically, in the prior art, an entire upper lobe of the sine wave is integrated as a positive (+) signal, and an entire lower lobe of the sine wave is integrated as a negative signal (−).

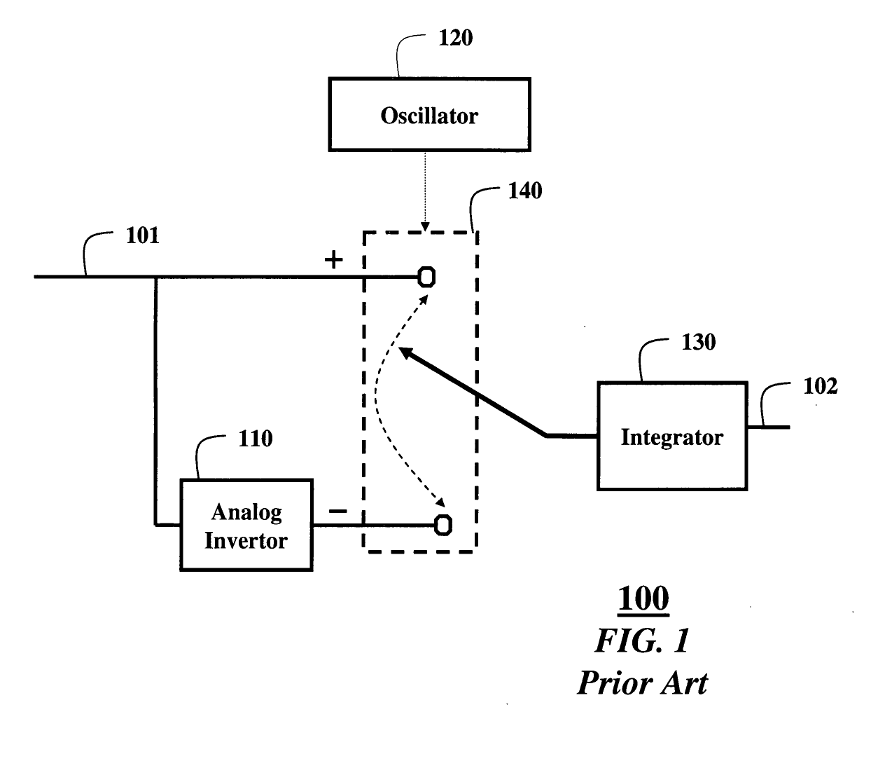

FIG. 4 shows a signal where an interfering third-harmonic exists at a carrier frequency 3F. Although one of the positive-going lobes is cancelled by a negative-going lobe, a second positive going lobe and a first negative going lobe are not cancelled. These two lobes are integrated positively and negatively respectively, and allow one third of the interfering signal to pass through the prior art synchronous demodulator of FIG. 1.

FIG. 5 shows a signal after the commutator switching of FIG. 2 is applied to the interfering third harmonic carrier. The third harmonic carrier loses one full lobe (as two half lobes) in each of the positive and negative half-waves of the sine wave. A total integral over the interfering signal is zero, indicating complete cancellation of the third harmonic.

FIG. 6 shows a signal after the commutator switching of FIG. 2 is applied to a first harmonic signal. Only a small amount of the desired signal is blocked, i.e., the zero crossings or 1−cos(30°)=0.133 of the desired signal. Even though there is about a 0.5 dB of loss of the desired signal, the signal to noise ratio is substantially improved because the interfering third harmonic is almost completely suppressed.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

I claim:

1. A method for minimizing harmonic interference in a radio receiver, comprising:
periodically switching a received signal to an integrator as a positive signal;
periodically switching the received signal to the integrator as a negative signal; and
periodically switching the integrator to block the received signal from the integrator to minimize harmonic interference.

2. The method of claim 1, in which a periodicity is at a rate of a carrier frequency of the received signal.

3. The method of claim 1, in which the switching is performed by a commutator switch having three positions, a first position connecting directly the received signal to the integrator as a positive signal, a second position connecting the received signal to the integrator via an inverter as a negative signal, and a third position connecting the integrator to ground to block the received signal from the integrator.

4. The method of claim 1, in which a first half of a first lobe and a last half of a last lobe in each half-cycle at a carrier frequency is blocked to eliminate third harmonic interference.

5. The method of claim 1, in which the switching during a desired phase of the received signal is blocked from 0 to 30 degrees, is positive from 30 degrees to 150 degrees, is blocked from 150 degrees to 210 degrees, is negative from 210 degrees to 330 degrees, and is blocked from 330 degrees to 360 degrees to eliminate third-harmonic interference.

6. The method of claim 1, in which a first half of a first lobe and a last half of a last lobe in each half-cycle at a carrier frequency is blocked to eliminate fifth harmonic interference.

7. The method of claim 1, in which periods the integrator is switched to ground designated by OFF are determined from an interfering N^{th} harmonic frequency according to OFF during 0±(180/N) degrees, and OFF during 180±(180/N) degrees, where N is a harmonic number of interference to be minimized.

8. An apparatus for minimizing harmonic interference in a radio receiver, comprising:
a three position switch having a first position connecting an integrator to a received signal, a second position connecting the integrator to an inverted received signal, and a third position connecting the integrator to ground; and
an oscillator configured to switch the three position switch at a rate of the received signal.

9. An apparatus for minimizing harmonic interference in a radio receiver, comprising:
an inverter;
an integrator;
a three position switch; and
an oscillator for periodically switching directly a received signal to the integrator as a positive signal via a first position of the three position switch, and periodically switching the received signal to the integrator as a negative signal via a second position of the three position switch, and periodically switching the integrator to ground via a third position of the three position switch to block the received signal from the integrator to minimize harmonic interference.

10. A method for minimizing harmonic interference in a radio receiver, comprising:
periodically switching a received quadrature signal to a first integrator as a first positive signal;
periodically switching the received quadrature signal to the first integrator as a first negative signal;
periodically switching the first integrator to ground to block the received quadrature signal from the first integrator to minimize harmonic interference;
periodically switching the received signal to a second integrator as a second positive signal;
periodically switching the received signal to the second integrator as a second negative signal;
periodically switching the received signal to ground to block the received quadrature signal from the second integrator; and
synchronizing the switching action of the first and second integrators to substantially 90 degrees out of phase with a desired carrier frequency.
